(19) United States
(12) Patent Application Publication
(10) Pub. No.: US 2025/0265036 A1
(43) Pub. Date: Aug. 21, 2025

(54) KIOSK SYSTEM AND OPERATION METHOD THEREOF UTILIZING GENERATIVE ARTIFICIAL INTELLIGENCE

(71) Applicant: TAKY Corp., Busan (KR)

(72) Inventor: Seong Hwan NOH, Busan (KR)

(73) Assignee: TAKY Corp., Busan (KR)

(21) Appl. No.: 18/911,288

(22) Filed: Oct. 10, 2024

(30) Foreign Application Priority Data
Feb. 16, 2024 (KR) 10-2024-0022374

(51) Int. Cl. G06F 3/16; G06F 3/0488; G06Q 20/18; G10L 15/22

(52) U.S. Cl. CPC G06F 3/167; G06F 3/0488; G06Q 20/18; G10L 15/22

(57) ABSTRACT

A kiosk system and an operation method thereof utilizing generative artificial intelligence are provided, the kiosk system and the operation method thereof utilizing the generative artificial intelligence that enables a user to use a kiosk easily and conveniently through his or her conversation with the artificial intelligence even though the kiosk user does not know how to use the kiosk, the kiosk system being installed in a public place for touch screen-type information transmission, and the kiosk system including a kiosk configured to enable communication with the user in natural language by utilizing a generative artificial intelligence technology, and perform information transmission functions including screen switching, menu selection, and payment through conversation with the user, and a cloud server configured to communicate with the kiosk, and store kiosk information including customer information, menu information, and payment information in a database.

### CROSS REFERENCE TO THE RELATED APPLICATIONS

This application is based upon and claims priority to Korean Patent Application No. 10-2024-0022374, filed on Feb. 16, 2024, the entire contents of which are incorporated herein by reference.

### TECHNICAL FIELD

The present disclosure relates to a kiosk system and an operation method thereof utilizing generative artificial intelligence and, more particularly, to an operation method of an active artificial intelligence kiosk system and a kiosk system utilizing generative artificial intelligence, which enable artificial intelligence having learned how to use the kiosk systems to realize customized services such as changing the kiosk systems by identifying the context of voice conversations with users in order for customers to use kiosks more conveniently.

### BACKGROUND

Due to technological advancements, COVID-19, and the like, the use of kiosks is increasing in many places such as convenience stores, fast food restaurants, and cafes in line with the era of untact (i.e., non-face-to-face contact). Furthermore, the number of places that only have kiosks is also gradually increasing in the name of reducing labor costs.

As for such kiosks, in order to solve problems of inconvenience in use for customers, kiosks utilizing various technologies such as “CUSTOMIZED KIOSK USING FACIAL RECOGNITION AND CONTROL METHOD USING SAME” proposed in Korean Patent Application Publication No. 10-2022-0120878 have been introduced, but there has been a problem in that using the kiosks is inconvenient for users such as children or the elderly who do not know how to use the kiosks at all.

Meanwhile, with the recent development of artificial intelligence technology, it is possible to communicate impeccably with people in natural language by using a GPT artificial intelligence engine, which is a fundamental artificial intelligence model of ChatGPT.

Therefore, efforts to develop a kiosk are ongoing, wherein the kiosk is applied with active artificial intelligence technology that is configured to obtain customer information, specific consultation guidelines, and contexts, provide users with customized system changes and customer guidance, and control the kiosk with voice control through different actions in specific situations.

### Documents of Related Art

### Patent Documents

(Patent Document 1) Korean Patent Application Publication No. 10-2022-0120878 (Feb. 24, 2021)

### SUMMARY

An objective of the present disclosure for solving the above-described problem is to provide a kiosk system and an operation method thereof utilizing generative artificial intelligence, wherein artificial intelligence guides a user through conversation on a usage method that the user is curious about, and the user is enabled to give commands to the artificial intelligence through the conversation instead of entering the commands by hand, thereby performing screen switching, menu selection, payment, etc.

The objective of the present disclosure is not limited to the objective mentioned above, and other objectives not mentioned herein will be clearly identified by those skilled in the art from the following description.

In order to achieve the above objective, according to the present invention, there is provided a kiosk system utilizing generative artificial intelligence, the kiosk system being installed in a public place for touch screen-type information transmission, and the kiosk system including: a kiosk configured to enable communication with a user in natural language by utilizing a generative artificial intelligence technology, and perform information transmission functions including screen switching, menu selection, and payment through conversation with the user; and a cloud server configured to communicate with the kiosk, and store kiosk information including customer information, menu information, and payment information in a database.

In addition, the kiosk may include: a voice input unit configured to operate depending on whether the user selects an artificial intelligence function or not, receive input of the user's voice, convert the input voice into text, and transmit the text to the cloud server; a cloud server response reception unit configured to receive, from the cloud server, response data obtained by determining what action the artificial intelligence should perform on the voice; and a kiosk artificial intelligence control unit configured to control an operation of the kiosk on the basis of the response data.

In addition, the cloud server may include an artificial intelligence response generation unit configured to convert, by a generative artificial intelligence model having learned how to use the kiosk in advance, the text received from the voice input unit into a vector to identify a context, generate the response data for the user's question or kiosk control, and then transmit the response data to the cloud server response reception unit.

In addition, the artificial intelligence response generation unit may transmit the response data for requesting an additional question to the cloud server response reception unit in a case of identifying the context as one not suitable for the kiosk control.

In addition, the kiosk may further include a tip request unit for requesting a tip for a service that provides a result according to the response data.

In addition, the kiosk may display an animation of each operation step of the artificial intelligence on a screen in order to visually allow the user to know what step the artificial intelligence is at.

Meanwhile, according to another aspect, there is provided a method of operating a kiosk utilizing generative artificial intelligence, the method being performed by at least one processor, and the method including: entering, by the kiosk, a voice command standby state after providing voice guidance for a generative artificial intelligence function when receiving an operation command of the generative artificial intelligence function; receiving, by the kiosk, input of a user's voice, converting the input voice into text, and then transmitting command data to a cloud server; switching, by the kiosk, to a standby state until receiving response data from the cloud server; converting, by the cloud server, the text received from the kiosk into a vector, inputting the vector into a generative artificial intelligence model having learned how to use the kiosk in advance, and identifying a context of what action the generative artificial intelligence model should perform; generating, by the cloud server, the response data for the user's question or kiosk control on the basis of a result of the context identification, and then transmitting the response data to the kiosk; and providing, by the kiosk, the voice guidance to the user and controlling an operation of the kiosk on the basis of the response data received from the cloud server.

In addition, the generating and then transmitting of the response data to the kiosk is performed by branching into: generating, by the generative artificial intelligence model, a usage method as text in a case where the context is about a usage question; or loading the response data corresponding to a scenario stored in a database in a case where the context is about a kiosk control command.

The loading of the response data corresponding to the scenario stored in the database may transmit the response data for requesting an additional question to the kiosk in a case where the result of the context identification is the control command not corresponding to the database.

In addition, the method may further include requesting, by the generative artificial intelligence model, a tip for providing a conversational guidance service, after the controlling of the operation of the kiosk.

Meanwhile, each of the steps may further perform displaying a status animation corresponding to each step on the kiosk in order to visually show what step a current operation of the kiosk is at.

According to the present disclosure, the kiosk system and the operation method thereof utilizing the generative artificial intelligence have an effect of allowing the artificial intelligence to support a user to use the kiosk system easily and conveniently, so as to improve the convenience of the user through his or her conversation with the artificial intelligence even though the kiosk user does not know a usage method.

### BRIEF DESCRIPTION OF THE DRAWINGS

FIG. 1 is a configuration diagram illustrating a kiosk system utilizing generative artificial intelligence according to the present disclosure.

FIG. 2 is a block diagram illustrating a kiosk constituting the kiosk system utilizing the generative artificial intelligence according to the present disclosure.

FIG. 3 is a view illustrating specific operations (i.e., 2-step) in a cloud server constituting the kiosk system utilizing the generative artificial intelligence according to the present disclosure.

FIG. 4 is an exemplary view illustrating operation steps of the artificial intelligence in the kiosk constituting the kiosk system utilizing the generative artificial intelligence according to the present disclosure.

FIG. 5 is a flowchart illustrating the overall flow of a method of operating a kiosk utilizing generative artificial intelligence according to another aspect of the present disclosure.

FIG. 6 is a detailed flowchart illustrating the flow of the method of operating the kiosk utilizing the generative artificial intelligence according to another aspect of the present disclosure.

### DETAILED DESCRIPTION OF THE EMBODIMENTS

Benefits and features of the present disclosure and methods of accomplishing the same may be identified more readily by reference to the following detailed description of an exemplary embodiment and the accompanying drawings. However, the present disclosure is not limited to the exemplary embodiment disclosed below, but will be implemented in a variety of different forms. The exemplary embodiment is provided only to complete the embodiment of the present disclosure and to completely inform the scope of the present disclosure to those skilled in the art to which the present disclosure pertains, and the present disclosure is only defined by the scope of the claims.

Hereinafter, the exemplary embodiment of the present disclosure will be described in detail with reference to the accompanying drawings. The same reference numerals refer to the same components regardless of the drawings, and “and/or” includes each and every combination of one or more of the mentioned items.

The terminology used herein is for the purpose of describing the particular exemplary embodiment only and is not intended to be limiting of the present disclosure. In the present specification, the singular form also includes the plural form unless otherwise specified in the phrase. As used herein, “comprises” and/or “comprising” does not exclude the presence or addition of one or more other components in addition to the mentioned components.

OpenAI or OpenAI API used in the present specification may be interpreted as a technology for performing a role of utilizing content entered in a prompt, a pre-made optimized prompt, customer information so as to provide a friendly response, or performing a role of identifying a context of a customer's question, determining what the question is about, and passing a determined result to a toolchain agent of a LangChain framework.

In addition, naturally, the toolchain agent of the LangChain framework may be interpreted as to perform various roles including: a role of connecting what OpenAI API determines to a function to form a connection for a specific type; a role of changing a system of an actual customer; and a role of connecting to a storage of vectors, which are similar to prompts, artificial intelligence models used, and inputs of a user, and then transmitting result values to a kiosk through the connection to cause a specific action.

Unless otherwise defined, all terms (including technical and scientific terms) used in the present specification may be used in a sense that may be commonly identified by those skilled in the art. In addition, terms defined in the commonly used dictionary are not ideally or excessively interpreted unless specifically defined.

Hereinafter, a preferred exemplary embodiment of the present disclosure will be described in detail with reference to the attached drawings.

FIG. 1 is a configuration diagram illustrating a kiosk system utilizing generative artificial intelligence according to the present disclosure.

Referring to FIG. 1, the kiosk system utilizing generative artificial intelligence according to the present disclosure is installed in a public place for touch screen-type information transmission, and the kiosk system largely includes a kiosk 100 and a cloud server 200.

First, the kiosk 100 is configured to enable communication with a user in natural language by utilizing generative artificial intelligence technology, and perform information transmission functions including screen switching, menu selection, and payment through conversation with the user.

Here, the information transmission functions are not limited thereto, and may naturally be set or configured to perform various functions depending on locations or purposes, such as menu recommendation, route guidance, and usage guidance.

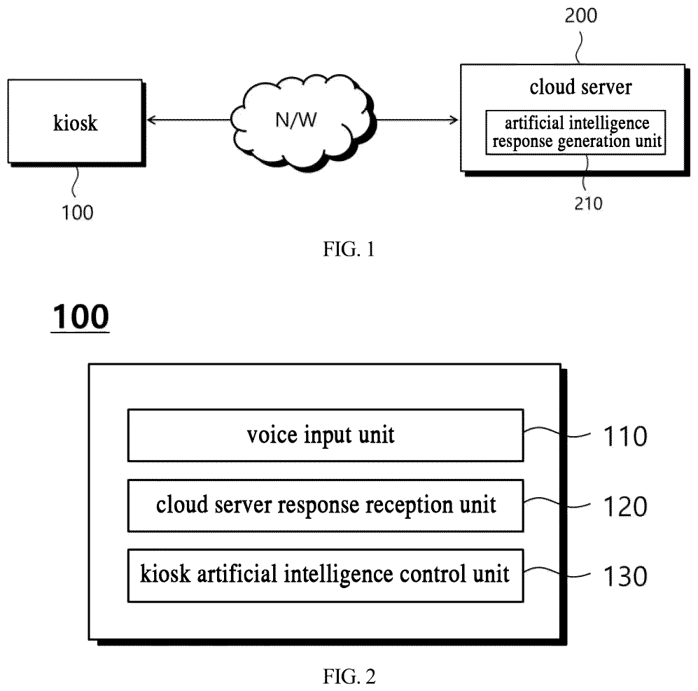

FIG. 2 is a block diagram illustrating a kiosk constituting the kiosk system utilizing the generative artificial intelligence according to the present disclosure.

Referring to FIG. 2, when describing the kiosk 100 in more detail, the kiosk 100 may be configured to include a voice input unit 110, a cloud server response reception unit 120, and a kiosk artificial intelligence control unit 130.

The voice input unit 110 performs operations thereof depending on whether a user selects an artificial intelligence function or not, and performs a role of receiving the user's voice, converting the input voice into text, and transmitting the text to a cloud server.

In this case, the kiosk 100 is configured to have an artificial intelligence button that may be pressed anywhere on a screen so as to be able to call and use the artificial intelligence at any time. Whether the user selects the artificial intelligence function or not may mean an operation that when the artificial intelligence button is pressed, the artificial intelligence provides simple guidance through voice and waits to receive the user's voice command.

In addition, the voice input unit 110 may be configured to convert the user's voice into text through an speech to text (STT) service when there is a voice command from the user, and for example, the voice input unit 110 may be configured to enable the artificial intelligence to transmit the user's voice command to the cloud server 200 through https communication by using the STT.

The cloud server response reception unit 120 receives, from the cloud server 200, response data obtained by determining what action the artificial intelligence should perform in response to the user's voice command.

The kiosk artificial intelligence control unit 130 performs a role of controlling the operation of the kiosk 100 on the basis of the response data.

For example, the kiosk artificial intelligence control unit 130 may be configured to ask an additional question to the user, or guide or display the user's desired result by using text to speech (TTS) technology on the basis of the response data.

Meanwhile, although not shown in the drawings, the kiosk 100 may be configured to further include a tip request unit (not shown) for requesting a tip for a service that provides results according to the response data.

The tip request unit may apply upselling technology that recommends paying a tip when the artificial intelligence provides convenience to the user.

Next, the cloud server 200 communicates with the kiosk 100 and stores kiosk information including customer information, menu information, and payment information in a database.

In addition, the cloud server 200 includes an artificial intelligence response generation unit 210 configured to convert, by the generative artificial intelligence model having learned how to use the kiosk 100 in advance, the text received from the voice input unit into vectors to identify a context of the text, generate response data for the user's question or kiosk control, and then transmit the response data to the cloud server response reception unit 120.

The artificial intelligence response generation unit 210 is configured to transmit the response data for requesting an additional question to the cloud server response reception unit 120 in a case of identifying the context as one not suitable for the kiosk control.

To describe in more detail the artificial intelligence response generation unit 210 including such a configuration, the artificial intelligence response generation unit 210 performs a role of loading a pre-designated kiosk usage manual file to generate overlapping content with a preset number of characters, and dividing the content into the preset number of characters to generate a plurality of chunks.

This is because an artificial intelligence model, such as a large language model (LLM), has a limit on the length of a context, so documents such as a manual should be divided into chunks so as to be used. In this case, the generated chunks are required to overlap adjacent chunks in order to prevent incorrect answers from being made due to the content of the kiosk usage manual that is cut off in the middle during the dividing process, and accordingly, it is preferable to divide the characters into a size of 2,000 characters, and to set an overlapping size to be 500 characters.

In addition, the artificial intelligence response generation unit 210 converts each generated chunk into a vector (e.g., returns a string as a 1536-dimensional vector value) through an embedding operation, and stores the vectors in a vector storage.

Meanwhile, the artificial intelligence response generation unit 210 performs operations of receiving information about a user who has accessed the kiosk 100 from the kiosk 100, accessing a database through the customer's serial number, and receiving kiosk information including language used, page information, device information, and user information. The kiosk information may be received in the form of a JSON file, but is not limited thereto.

In addition, the artificial intelligence response generation unit 210 serves a role of converting the received kiosk information into text and inputting this text into a prompt including an example and instructions related to role assignment for usage and the like of the preset kiosk system, and serves a role of inputting the artificial intelligence model, which is to be used as LangChain, and the preset prompt and chunks into a prompt. This means that the artificial intelligence response generation unit 210 is used as a fundamental tool for guiding users.

The artificial intelligence response generation unit 210 is configured to receive a user's voice command, receive an answer from LangChain, an agent, and OpenAI API in order to determine what function the user desires, trigger a predetermined specific function, and consequently, transmit a result, a type, an action, and data (see [Table 1] below) to the kiosk 100, so as to perform the kiosk control of displaying a modal or placing an order.

TABLE 1

| | | Context of | Transmission- | Transmission- | Transmission- |
|---|---|---|---|---|---|
| Page | System change | conversation | action | type | data |
| start | checkin-takeout | takeout checkin | show | checkin | takeout |
| start | checkin-store | store checkin | show | checkin | store |
| start | calling | calling staff | show | staff | |
| | staff | | | | |
| start | changing language | changing to | do | lan | ko |
| | | Korean | | | |
| start | changing language | changing to | do | lan | ch |
| | | Chinese | | | |
| start | changing language | changing to | do | lan | jp |
| | | Japanese | | | |
| start | changing language | changing to | do | lan | en |
| | | English | | | |
| menu | requesting menu | order | show | order | order menu name |
| menu | cancelling | cancellation | page | first | |
| | menu | | | | |
| menu | recommending | recommending | 2-step | recommend | |
| | menu | menu | | | |
| payment | payment | payment | show | pay | |
| screen | | | | | |
| payment | cancellation | cancellation | page | menu | |
| screen | | | | | |
| whole | Chatbot | question not | | | |
| | | corresponding to | | | |
| | | anything else | | | |
| 2-step | gender-based | gender | recommend | gender | |
| | recommendation | | | | |
| 2-step | age-based | age | recommend | age | |
| | recommendation | | | | |
| 2-step | popularity-based | popularity | recommend | like | |
| | recommendation | | | | |

FIG. 3 is a view illustrating specific operations (i.e., 2-step) in the cloud server constituting the kiosk system utilizing the generative artificial intelligence according to the present disclosure.

In this case, as shown in FIG. 3, the artificial intelligence response generation unit 210 is configured to ask the user a question again by using the 2-step for cases requiring specific information, and then perform the operation thereof again on the basis of this information.

For example, when the user asks for a recommendation for food, the artificial intelligence response generation unit 210 provides a 2-step question such as “Among age group, gender, and popularity, which criteria would you like to be recommended for food?”, and then recommends the food by way of displaying a menu on a screen through an algorithm that matches each of these criteria.

This means that artificial intelligence actively performs functions by identifying a specific context.

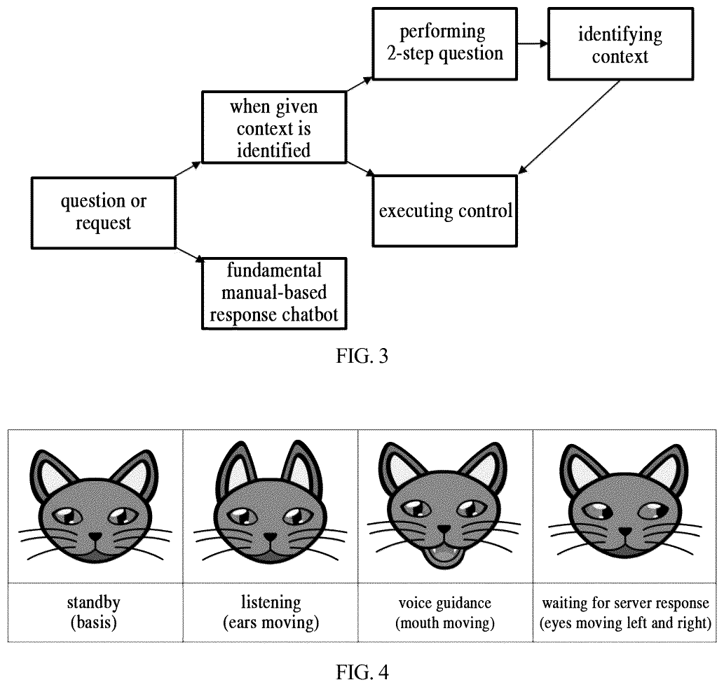

FIG. 4 is an exemplary view illustrating operation steps of the artificial intelligence in the kiosk constituting the kiosk system utilizing the generative artificial intelligence according to the present disclosure.

Additionally, as shown in FIG. 4, the kiosk system utilizing the generative artificial intelligence according to the present disclosure may be configured to display an animation of each operation step of the artificial intelligence on a screen so that the kiosk 100 may visually allow the user to know what step the artificial intelligence is at.

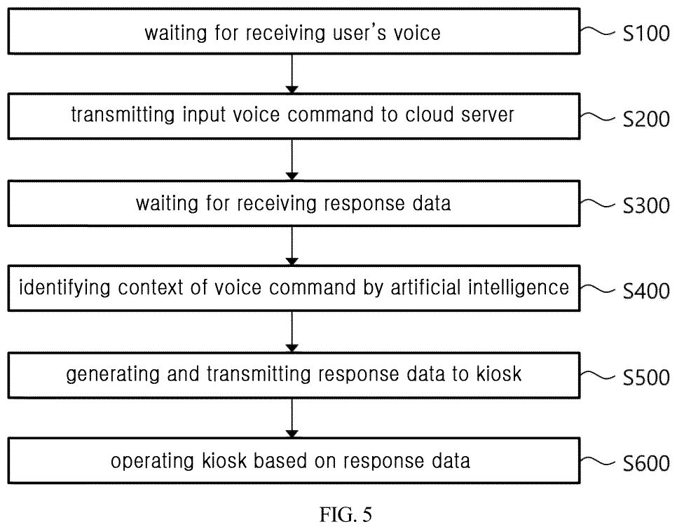

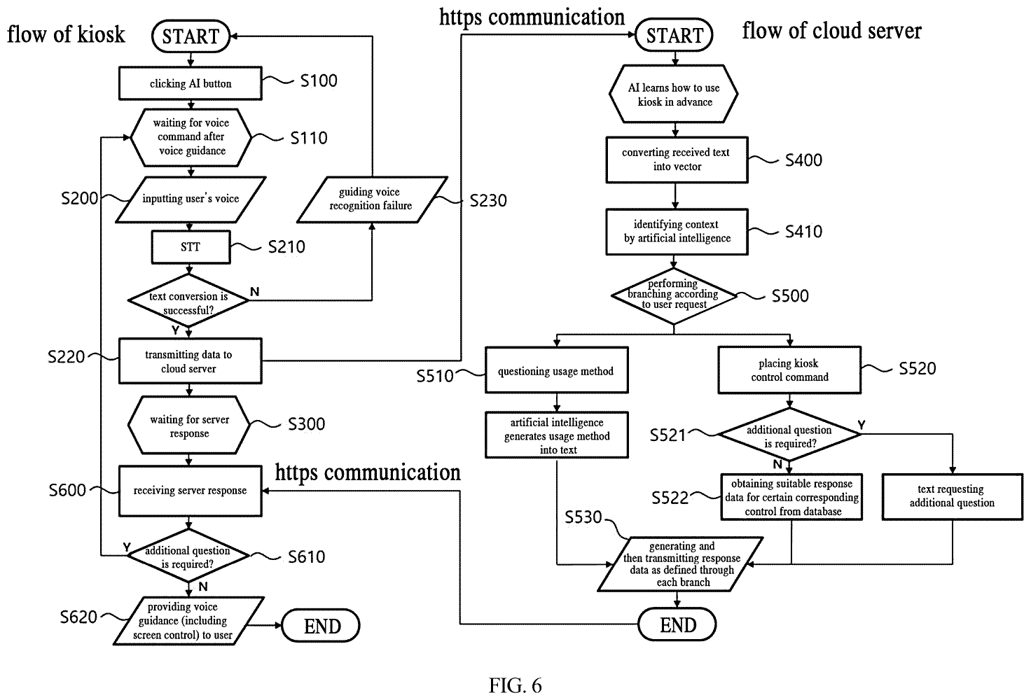

FIG. 5 is a flowchart illustrating the overall flow of a method of operating a kiosk utilizing generative artificial intelligence according to another aspect of the present disclosure. FIG. 6 is a detailed flowchart illustrating the flow of the method of operating the kiosk utilizing the generative artificial intelligence according to another aspect of the present disclosure.

Below, the method of operating the kiosk utilizing the generative artificial intelligence according to another aspect of the present disclosure will be described.

Referring to FIG. 5, the method for operating the kiosk utilizing the generative artificial intelligence according to another aspect of the present disclosure first performs step S100 of providing, by artificial intelligence, simple guidance for a user through voice and waiting to receive a voice command from the user when an artificial intelligence button that may be pressed anywhere on a screen is pressed, so that the artificial intelligence may be called and used at any time on the kiosk 100.

Next, the method for operating the kiosk performs step S200 of using, by the artificial intelligence, voice recognition (e.g., STT) to transmit the command to a cloud server 200 through communication (e.g., https) when there is the voice command from the user, and step S300 of waiting to receive response data by the kiosk 100.

Then, the method for operating the kiosk performs step S400 of identifying, by the cloud server 200, context of the voice command for which what action the artificial intelligence using the generative artificial intelligence should perform, and step S500 of performing a system branch operation to generate response data that matches a result of the branch, and transmitting the response data to the kiosk 100 through communication (e.g., https).

After that, the method for operating the kiosk performs step S600 of asking, by the kiosk 100, an additional question or showing a desired result to the user by using voice synthesis (e.g., TTS) technology, and thus the main technical points of the present disclosure is to realize a customized service, such as the artificial intelligence having learned how to use the kiosk system changes the kiosk system by identifying the context of voice conversation with the user, in order for each user to be able to use the kiosk 100 more conveniently.

Referring to FIG. 6, to describe the above-described series of processes in more detail, the method of operating the kiosk utilizing the generative artificial intelligence according to another aspect of the present disclosure, the method being performed at least one processor, first performs step S100 of receiving, by a kiosk 100, an operation command of a generative artificial intelligence function, and then performs step S110 of entering a voice command standby state after providing voice guidance for the generative artificial intelligence function.

Next, the method of operating the kiosk performs step S200 of receiving, by the kiosk 100, the user's voice, step S210 of converting the user's voice into text, and then step S220 of transmitting command data to a cloud server 200.

In a case where text conversion fails in step S210 of converting the text, the method performs step S230 of considering this case as a voice recognition failure and performing guidance action.

Next, the method performs step S300 of switching to a standby state until the kiosk 100 receives response data from a cloud server 200.

Next, the method performs step S400 of converting, by the cloud server 200, the text received from the kiosk 100 into vectors and step S410 of inputting the converted vectors into a generative artificial intelligence model having learned how to use the kiosk in advance, and identifying a context of what action the generative artificial intelligence model should perform.

Next, the method performs step S500 of generating, by the cloud server 200, the response data for the user's question or kiosk control on the basis of the result of the context identification, and then transmitting the response data to the kiosk 100.

Here, in a case where the context is about a question about usage, the method performs step S510 of generating, by the generative artificial intelligence model, a usage method into text, and in a case of step S520 where the context is about a kiosk control command, the method branches into and performs step S522 of loading the response data corresponding to a scenario stored in a database.

Meanwhile, in a case of step S521 where the result of the context identification is a control command not corresponding to the database, the method performs transmitting response data for requesting an additional question to the kiosk.

Next, the method performs step S600 of providing, by the kiosk 100, voice guidance to the user and controlling the operation of the kiosk on the basis of the response data received from the cloud server 200.

Meanwhile, after step S600 of controlling the operation of the kiosk, the method further performs requesting, by the generative artificial intelligence model, a tip for providing a conversational guidance service.

In addition, each of the above steps is characterized by further performing at any time displaying a status animation corresponding to each step on the kiosk in order to visually show what step a current operation of the kiosk is at.

Although the exemplary embodiment of the present disclosure has been described above with reference to the accompanying drawings, it will be identified that those skilled in the art to which the present disclosure pertains may implement the present disclosure in other specific forms without departing from the technical spirit or essential features thereof. Therefore, the exemplary embodiment described above is to be identified in all respects as illustrative and not restrictive.

What is claimed is:

1. A kiosk system utilizing generative artificial intelligence, the kiosk system being installed in a public place for touch screen-type information transmission, and the kiosk system comprising:
a kiosk configured to enable communication with a user in natural language by utilizing a generative artificial intelligence technology, and perform information transmission functions comprising screen switching, menu selection, and payment through conversation with the user; and
a cloud server configured to communicate with the kiosk, and store kiosk information comprising customer information, menu information, and payment information in a database.

2. The kiosk system according to claim 1, wherein the kiosk comprises:
a voice input unit configured to operate depending on whether the user selects an artificial intelligence function or not, receive input of a user's voice, convert an input voice into text, and transmit the text to the cloud server;
a cloud server response reception unit configured to receive, from the cloud server, response data obtained by determining what action the generative artificial intelligence should perform on the voice; and
a kiosk artificial intelligence control unit configured to control an operation of the kiosk based on the response data.

3. The kiosk system according to claim 2, wherein the cloud server comprises:
an artificial intelligence response generation unit configured to convert, by a generative artificial intelligence model having learned how to use the kiosk in advance, the text received from the voice input unit into a vector to identify a context, generate the response data for a user's question or kiosk control, and then transmit the response data to the cloud server response reception unit.

4. The kiosk system according to claim 3, wherein the artificial intelligence response generation unit transmits the response data for requesting an additional question to the cloud server response reception unit in a case of identifying the context as one not suitable for the kiosk control.

5. The kiosk system according to claim 2, wherein the kiosk further comprises:
a tip request unit for requesting a tip for a service that provides a result according to the response data.

6. The kiosk system according to claim 1, wherein the kiosk displays an animation of each operation step of the generative artificial intelligence on a screen in order to visually allow the user to know what step the generative artificial intelligence is at.

7. A method of operating a kiosk utilizing generative artificial intelligence, the method being performed by at least one processor, and the method comprising:
step a) of entering, by a kiosk, a voice command standby state after providing voice guidance for a generative artificial intelligence function when receiving an operation command of the generative artificial intelligence function;
step b) of receiving, by the kiosk, input of a user's voice, converting an input voice into text, and then transmitting command data to a cloud server;
step c) of switching, by the kiosk, to a standby state until receiving response data from the cloud server;
step d) of converting, by the cloud server, the text received from the kiosk into a vector, inputting the vector into a generative artificial intelligence model having learned how to use the kiosk in advance, and identifying a context of what action the generative artificial intelligence model should perform;
step e) of generating, by the cloud server, the response data for a user's question or kiosk control based on a result of a context identification, and then transmitting the response data to the kiosk; and
step f) of providing, by the kiosk, the voice guidance to the user and controlling an operation of the kiosk based on the response data received from the cloud server.

8. The method according to claim 7, wherein step e) is performed by branching into:
step e-1) of generating, by the generative artificial intelligence model, a usage method as text in a case where the context is about a usage question; or
step e-2) of loading the response data corresponding to a scenario stored in a database in a case where the context is about a kiosk control command.

9. The method according to claim 8, wherein step e-2) transmits the response data for requesting an additional question to the kiosk in a case where the result of the context identification is the kiosk control command not corresponding to the database.

10. The method according to claim 7, further comprising:
requesting, by the generative artificial intelligence model, a tip for providing a conversational guidance service, after step f).

11. The method according to claim 7, wherein each of the steps further comprises:
displaying a status animation corresponding to each step on the kiosk in order to visually show what step a current operation of the kiosk is at.
